(19) United States
(12) Patent Application Publication
(10) Pub. No.: US 2022/0063252 A1
(43) Pub. Date: Mar. 3, 2022

(54) RECYCLABLE PRINTED PACKAGING MATERIALS AND RELATED METHODS

(71) Applicant: ePac Holdings, LLC, Austin, TX (US)

(72) Inventors: Sangameshwar Sangmule, La Crosse, WI (US); Jack Knott, Austin, TX (US)

(21) Appl. No.: 17/003,119

(22) Filed: Aug. 26, 2020

(51) Int. Cl. B32B 27/08; C09D 11/101; B32B 27/32; B32B 7/12; B05D 3/06

(52) U.S. Cl. CPC B32B 27/08; C09D 11/101; B32B 27/32; B32B 7/12; B05D 3/068; B32B 2307/75; B32B 2323/046; B32B 2305/72; B32B 2307/304; B32B 2307/546; B32B 2255/10

(57) ABSTRACT

Methods of making recyclable flexible packaging material include steps of printing ink onto a recyclable polymer print film and forming a heat resistant coating on the print film. The coated and printed film can further be laminated to a sealant film of a same or similar recyclable polymer to form a recyclable laminate material suitable for heat sealable pouching applications.

### TECHNICAL FIELD

The present disclosure relates generally to recyclable printed flexible packaging materials and methods of making the same.

### BACKGROUND

Many types of flexible packaging (such as pouch packaging) are constructed from multilayer films which include multiple materials. The multiple materials can each be selected to impart various properties to the package, including processability, barrier and sealant performance, and aesthetics. However, this multi-material construction poses challenges to the recycling of flexible packaging. The disparate properties of the various materials typically means that each material requires different recovery and recycling processes, if the material is amenable to recycling at all. Recycling this packaging therefore involves additional sorting, separation, and processing steps, such that the added complexity typically renders the packaging unacceptable for established recycling streams.

One approach to constructing recyclable flexible packaging materials involves using single or multiple layers of a single recyclable material. However, while this monomaterial construction can provide enhanced recyclability, it can also require sacrificing other properties such as processability. As set forth below, the present disclosure encompasses laminated and other flexible packaging materials having a monopolymer construction (or near monopolymer construction) that provides a combination of recyclability and suitability for pouching processes.

### BRIEF DESCRIPTION OF THE DRAWINGS

To easily identify the discussion of any particular element or act, the most significant digit or digits in a reference number refer to the figure number in which that element is first introduced.

FIG. 1A shows a diagram of a cross-sectional view of a recyclable flexible packaging material 100 in accordance with an embodiment.

FIG. 1B shows a diagram of an exploded cross-sectional view of the recyclable flexible packaging material 100 shown in FIG. 1A.

FIG. 2A shows a diagram of a cross-sectional view of a recyclable flexible packaging material 200 in accordance with another embodiment.

FIG. 2B shows a diagram of an exploded cross-sectional view of the recyclable flexible packaging material 200 shown in FIG. 2A.

FIG. 3A shows a diagram of a cross-sectional view of a recyclable flexible packaging material 300 in accordance with another embodiment.

FIG. 3B shows a diagram of an exploded cross-sectional view of the recyclable flexible packaging material 300 shown in FIG. 3A.

### DETAILED DESCRIPTION

The components of the embodiments as generally described and illustrated herein can be arranged and designed in a wide variety of different configurations. Thus, the following more detailed description of various embodiments is not intended to limit the scope of the present disclosure but is merely representative of various embodiments. It will be appreciated that various features are sometimes grouped together in a single embodiment, figure, or description thereof for the purpose of streamlining the disclosure. Many of these features may be used alone and/or in combination with one another.

Conventional flexible packaging utilizes combinations of film materials that, while advantageous in some respects, can present challenges to the recycling of such packaging. For example, one such conventional packaging material comprises a combination of polyethylene terephthalate (PET) and polyethylene (PE). Polyethylene films are useful as sealant layers as they can readily melt to form strong seals when pressed together by heat sealing equipment. PET, on the other hand, has high heat resistance and does not melt or soften even at 400° F., making PET-based laminates suitable for pouching processes that include steps in which pouch material is exposed to high temperatures. One drawback of PET/PE laminates is that they are generally not recyclable due to the difficulty in separating the two polymeric materials. While PE monomaterials are more readily recyclable, the tendency of PE films to soften and stretch with increasing temperature makes it difficult to pouch full-PE packaging material. Automated pouching systems employ smooth intermittent motion to position, fill, and heat-seal pouches. A particular challenge with pouching with monopolymer materials arises with heat sealing, as the hot heat seal jaws impart heat to the film when they come in contact to produce the seal. This high heat causes monopolymer PE films to stretch, causing misalignment while producing the pouch and resulting in higher waste, longer set up time, and poor package quality.

The present disclosure encompasses flexible packaging materials and articles, and methods of making such materials and articles having a monopolymer construction (or near monopolymer construction) that provides a combination of recyclability and suitability for pouching processes. In accordance with embodiments in the present disclosure, methods of making a recyclable flexible packaging material generally comprise printing an ink onto a surface of a print film formed from a polymer material, coating a surface of the print film with a heat resistant coating, and curing the heat resistant coating to form a monopolymer (or near monopolymer) packaging material that is recyclable while being resistant to the high temperatures associated with some steps of pouching processes, particularly heat sealing. In certain embodiments, the print film is also laminated to a sealant film.

In some embodiments, a method of making a recyclable flexible packaging material comprises providing a print film comprising a polymer and having two mutually opposite sides, i.e. a first surface and a second surface. In accordance with these embodiments, the first surface is the surface of the film that will face the exterior of a pouch formed from the packaging material. In another aspect, the first surface is the surface of the print film that will come into closer proximity to, including direct contact with, high-temperature surfaces of pouching machinery, particularly heat sealing jaws. The method further comprises printing an ink on at least one of said surfaces, and further applying a coating to the first surface that confers a level of heat resistance to the surface and/or underlying layers of the laminate.

In some embodiments, the print film is made of a recyclable polymer suited for use in a flexible packaging application such as making a flexible pouch. In a particular embodiment, the print film comprises polyethylene. In more particular embodiments, the polyethylene is selected from low-density polyethylene (LDPE), linear low-density polyethylene (LLDPE), and combinations thereof. In certain embodiments, the print film comprises a multilayer film comprising a barrier layer such as ethylene vinyl alcohol (EVOH). For instance, the print film can comprise a multilayer film comprising an EVOH layer, with layers of PE disposed and/or adhered on either side. Such a multilayer film can be represented as PE/tie/EVOH/tie/PE. Typical tie and/or adhesive materials can be used. In such embodiments, the amount of EVOH in the multilayer print film can be less than about 5 wt %, such that the multilayer print film is still recyclable and can be considered a near monopolymer film layer in accordance with this disclosure.

In some embodiments, the method comprises printing an ink on the first surface of the print film and then coating the first surface with a radiation-curable coating formulation. In some embodiments, ink is reverse printed on the print film, i.e., printed on the second surface. Reverse printing is preferred in some packaging applications, because ink printed on an inner surface of packaging substrate does come in direct contact with human skin, or external storage and use conditions. In such embodiments, the print film may be selected to be sufficiently transparent such that a reverse printed image is visible through the print film. In certain embodiments, ink is printed on both sides of the print film.

Any number of inks and printing approaches that are used in printing on flexible packaging can be used in the printing step. Digital printing, flexographic printing, and gravure printing methods can be used in accordance with various embodiments to print inks suitable for the particular printing method. In certain embodiments, the ink is digitally printed on the print film. Inks include various liquid inks, such as liquid toners, water-based inks, solvent-based inks. Radiation-curable polymeric inks, such as those curable by ultraviolet radiation and electron beam radiation are also contemplated. The ink and the printing method may be selected for particular suitability for either surface or reverse printing as applicable, based on adhesion, clarity, color strength, compatibility with lamination adhesives, and the like.

In some embodiments, the surface to be printed can be treated or conditioned to assist the adhesion of ink. In particular embodiments a corona treatment is applied to the surface. Corona treatment involves treating the material with a low temperature corona discharge plasma to increase the surface tension of the surface, improving the wettability of the surface and promoting adhesion of the ink to the surface. The parameters of the corona treatment, such as power, can be selected to achieve the desired surface tension based on the respective characteristics of the ink and the printable surface. In a particular embodiment, the corona treatment power is from about 400 W to about 3000 W, or more particularly, from about 1000 W to about 2500 W, or from about 1500 W to about 2200 W about 2000 W. In a particular embodiment, the corona treatment power is about 2000 W.

In some embodiments, a radiation-curable coating formulation is applied to the first surface of the print film for the purpose of forming a heat resistant coating. In certain embodiments, the coating formulation is applied to the print film after the printing step, particularly in embodiments in which the first surface of the print film is printed with ink. As will be understood by those of skill in the art with the aid of the present disclosure, a number of available radiation-curable coating formulations may be suitable for use with the embodiments described herein. The coating formulation may be selected for particular properties including, but not limited to, curing chemistry, viscosity, adhesion to the print film material, ease of application and method of application, as well as post-curing properties such as flexibility, scratch resistance, stain resistance, clarity, transparency, and the like.

An aspect of the embodiments discussed herein is the creation of a flexible packaging material that is recyclable. Accordingly, the radiation-curable coating formulation can be selected for its suitability for forming a coating that does not significantly affect the recyclability of the resulting material. Coatings are not typically removed in recycling processes. They enter the extrusion stage of the process with the base material where they are either melted and blended with the base material, or remain solid and are filtered from the melted product. Recyclability of coated materials can be preserved when the coating is sufficiently thin so that it constitutes a low weight percentage of the total material and/or the coating is sufficiently compatible with the base material to allow blending. In some embodiments, an amount of radiation-curable coating formulation is used that will produce a heat resistant coating that constitutes less than about 5 wt % of the recyclable flexible packaging material as a whole. In some embodiments, the radiation-curable coating formulation is compatible with the print film material such that the heat resistant coating blends with the print film material when melted. In certain embodiments, a compatibilizer is added to the coating formulation to promote blending of the coating and the print film material.

Typical radiation-curable coating formulations include monomers and/or oligomers having functional groups, e.g. acrylate groups or (meth)acrylate groups, that can be induced to polymerize and/or form cross-links when the coating formulation is exposed to particular energy conditions. Monomer/oligomer types include without limitation monomers/oligomers of polyesters, urethanes, epoxies, and acrylics. In some cases, the exposure to the curing energy initiates the formation of ions or free radicals that facilitate the opening of existing bonds and formation of new ones in the constituent monomers/oligomers.

In some embodiments, the radiation-curable coating formulation is a light-curable coating formulation. Some light-curable formulations include a photoinitiator that facilitates the creation of reactive species upon absorption of light energy within a particular range of wavelengths, such as visible light or UV light. In more particular embodiments, the radiation-curable coating formulation comprises a UV-curable coating formula.

In some embodiments, the coating formulation is formulated to cure under electron beam (EB) irradiation. EB curing can provide certain advantages, such as the ability of EB radiation to penetrate coatings or substrates having a wide range of pigmentation or transparencies, and the high degree of spatial control and dosing control available with EB delivery. Those of skill in the art with the benefit of this disclosure will appreciate the certain details of electron beam irradiation as a general approach for curing polymeric compositions. In an aspect, the parameters of the electron beam irradiation, particularly the dose of radiation absorbed by the radiation-curable coating formulation, can be selected to produce a crosslinked coating that confers heat resistance to the packaging material as a result of the curing step together with other steps of the method. In some embodiments, curing comprises providing electron beam irradiation in a dose of from about 40 kiloGreys (kGy) to about 120 kGy. In more particular embodiments, the dose is from about 50 kGy to about 75 kGy, or more particularly about 60 kGy. In various embodiments, other parameters of EB delivery can be selected to provide the desired dose. In some embodiments, the EB dose is delivered using a source voltage of from about 85 kV to about 105 kV, and a line speed of from about 110 ft/min to about 600 ft/min.

In certain embodiments, the EB radiation further penetrates into the print layer upon which the coating formulation has been applied. Without being bound by any particular theory, in such instances, penetration of the EB radiation into the print layer can also crosslink at least a portion of the print layer to impart further heat resistance to the print layer and film structure. In some embodiments, the EB radiation penetrates into at least about 5%, at least about 10%, at least about 15%, at least about 20%, or at least about 25% of the thickness of the print layer to crosslink at least a portion of the print layer or otherwise impart heat resistance. In other embodiments, the EB radiation penetrates into between about 5% and about 50%, between about 10% and about 40%, or between about 15% and about 30% of the thickness of the print layer to crosslink at least a portion of the print layer or otherwise impart heat resistance.

In some embodiments, the radiation-curable coating formulation is applied to the first surface of the print film in an amount to produce a coating of a desired thickness. In some embodiments, an anilox roller is used to provide a selected amount of coating formula to the coating cylinder for application to the print film. In particular embodiments, the anilox roller has a volume of from about 1 billion cubic microns (BCM) to about 15 BCM. In more particular embodiments the roller volume is from about 5 BCM to about 10 BCM. In an embodiment, the roller volume is about 5 BCM. In another embodiment, the roller volume is about 10 BCM.

It will be understood that the sequence of various steps of the method can be selected so as to achieve different structural arrangements of the film's components. For example, in an embodiment, the method comprises printing the ink on one or both surfaces of the print film before coating the first surface. For instance, a first surface of the print film can be printed upon, after which a radiation-curable coating formulation can be applied to the first surface. In other embodiments, the radiation-curable coating formulation is applied to a first surface of the print film and cured before printing ink onto a second surface. For instance, a radiation-curable coating formulation can be applied to a first surface of a print film, after which it may be cured with EB irradiation. An opposing second surface of the print film can thereafter be printed upon, after which the print film can be laminated to a sealant layer (e.g., with the print side being sandwiched between the sealant and print films). In other embodiments, coating and curing are performed after printing. For instance, a second surface of a print film can be printed upon (e.g., reverse printed), after which the print film can be laminated to a sealant film (e.g., with the print side being sandwiched between the sealant and print films). After lamination, a radiation-curable coating formulation can be applied to an opposing first surface of the print film, after which it may be cured with EB irradiation.

In some embodiments, after printing and/or coating the print film, a sealant film can be laminated to the second surface of the print film with an adhesive to form a laminate material. In certain embodiments, the print film is laminated to the sealant film using a solventless adhesive. In other embodiments, solvent adhesives are used. Solventless adhesives as contemplated by the present disclosure include adhesives in which the chemicals that provide bonding are not carried in a solvent, whether water or a volatile substance, that must evaporate or be driven off to achieve bonding. A typical representative of a solventless adhesive comprises two (or more) components that react together in situ to form a cross-linked adhesive polymer. Examples of this kind of adhesive include a hydroxylated polyester or polyether which is reacted with a di- or polyisocyanate, and an epoxy resin which is reacted with compounds containing at least two active hydrogen atoms. It is to be understood that any solventless adhesive as defined above may be used in accordance with the embodiments described herein.

An aspect of the embodiments discussed herein is the creation of a recyclable flexible packaging material that is essentially a monopolymer material (or near monopolymer material). Accordingly, in some embodiments one or more properties of the sealant film are similar or substantially the same as those of the print film. For example, the sealant film and print film can be selected to have similar or the same thermoplastic properties. In another example, the sealant film and print film can be selected to be similarly compatible with a particular postconsumer recycling process. In certain embodiments, the sealant film and the print film comprise the same polymeric material, and more particularly have substantially the same composition. In a particular embodiment, both the sealant film and the print film are PE films. In more particular embodiments, both films comprise PE having substantially the same polymeric structure, e.g. both films may be LDPE, LLDPE, or combinations thereof. Similar to the print layer, in certain embodiments, the sealant film comprises a multilayer film comprising a barrier layer such as EVOH. For instance, the sealant film can comprise a multilayer film comprising an EVOH layer, with layers of PE disposed and/or adhered on either side. Such a multilayer film can be represented as PE/tie/EVOH/tie/PE. Typical tie and/or adhesive materials can be used. In such embodiments, the amount of EVOH in the multilayer sealant film can be less than about 5 wt % such that the multilayer sealant film is still recyclable and can be considered a near monopolymer film layer in accordance with this disclosure.

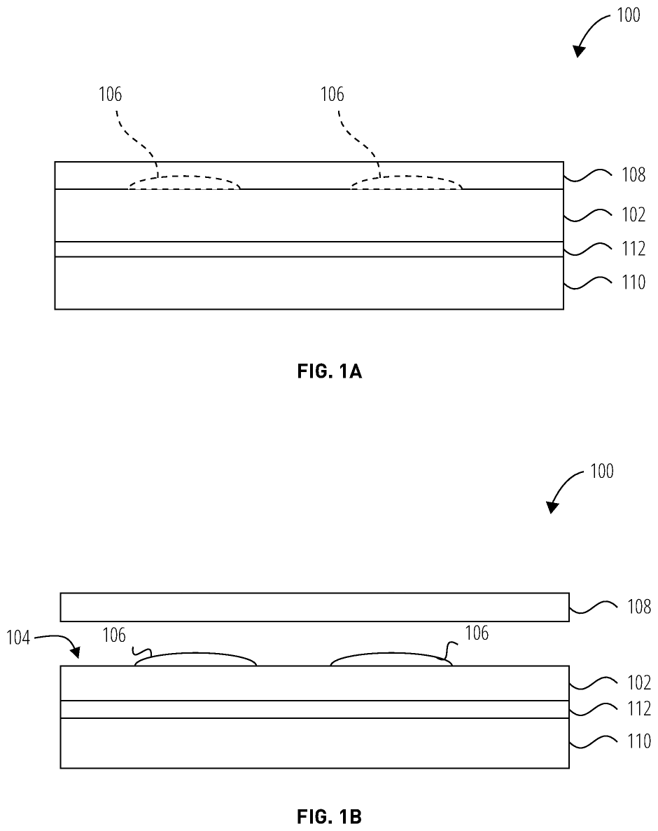

As shown in cross-sectional view diagram of FIGS. 1A and 1n an exploded view FIG. 1B, a recyclable flexible packaging material 100 in accordance with an embodiment comprises a print film 102 having a first surface 104 on which an ink 106 has been printed according to the methods described above, and also a second surface (not visible in the diagram) opposite side of the print film 102 from the first surface 104. In various embodiments, the print film is made of a recyclable polymer suited for use in a flexible packaging application. In a particular embodiment, the print film comprises polyethylene. In more particular embodiments, the polyethylene is selected from low-density polyethylene (LDPE), linear low-density polyethylene (LLDPE), and combinations thereof. As previously described, in certain embodiments, the print film 102 comprises a multilayer film comprising a barrier layer such as an EVOH layer, with layers of PE disposed on either side. In such embodiments, the amount of EVOH in the multilayer print film can be less than about 5 wt % such that the multilayer print film is still recyclable and can be considered a near monopolymer film layer in accordance with this disclosure. The print film 102 can be of a thickness of from about 0.7 mil to about 3.0 mil.

In particular embodiments, the ink 106 is a polymeric ink that can be cured by known methods so that the printed and cured ink 106 exhibits crosslinking among at least a portion of the monomers that make up the constituent polymers of the ink. In a particular aspect, crosslinking may also exist between monomers in the ink and monomers in the print film 102. In some embodiments, the printed ink 106 includes two or more layers of ink. In embodiments in which the ink 106 comprises polymeric ink, crosslinking may exist between adjacent layers of ink.

As also shown in FIGS. 1A and 1B, the recyclable flexible packaging material 100 further comprises a heat resistant coating 108 disposed on the first surface 104 and covering at least part of the first surface 104 and the ink 106 printed thereon. In an aspect the heat resistant coating can be formed by application of a radiation-curable coating formulation to the first surface 104 and curing the formulation by methods described above. In a particular embodiment, the heat resistant coating 108 is formed by application and EB radiation curing of the formulation. Accordingly, the heat resistant coating 108 exhibits crosslinking among at least a portion of the monomers that make up the constituent polymers of the coating. In some embodiments, crosslinking also exists between the heat resistant coating 108 and the print film 102. And in further embodiments, the EB radiation curing also penetrates into the print film 102, causing at least a portion of the print film 102 to crosslink and become more heat resistant.

As also shown in FIGS. 1A and 1B, the recyclable flexible packaging material 100 further comprises a sealant film 110 laminated to the second surface of the print film with an adhesive 112. The sealant film 110 can have a thickness from about 1.5 mil to about 4.5 mil. In a particular embodiment, the adhesive 112 is a solventless adhesive. Properties of solventless adhesives that can be used in accordance with the embodiment are described above, and the solventless adhesive may be any of these. As also described above, in particular embodiments, the sealant film 110 comprises PE. And in certain embodiments, the sealant film 110 comprises a multilayer film comprising a barrier layer such as an EVOH layer, with layers of PE disposed on either side. In such embodiments, the amount of EVOH in the multilayer sealant film can be less than about 5 wt % such that the multilayer sealant film is still recyclable and can be considered a near monopolymer film layer in accordance with this disclosure.

As discussed above, the respective materials of the print film 102, heat resistant coating 108, and sealant film 110 are selected so as to form a recyclable laminate material. In a particular embodiment, the sealant film 110 comprises a polymeric material having one or more properties in common with the material of the print film 102, including recyclability. In more a particular embodiment, the print film 102 and the sealant film 110 comprise the same polymeric material, e.g. polyethylene. The heat resistant coating 108 is also of a composition and a proportion of the total material mass so as to not negatively affect the recyclability of the product material. In certain embodiments, the heat resistant coating 108 is of a thickness so as to constitute about 5 wt % or less of the total specific weight of the recyclable flexible packaging material 100. Further, in embodiments in which the print film 102 and/or sealant film 110 comprises a multilayer film comprising a barrier layer such as an EVOH layer, the amount of EVOH can be less than about 5 wt % of the print film or sealant film layer so as to not negatively affect the recyclability of the overall film structure.

A further aspect of the recyclable flexible packaging material is that it exhibits increased heat resistance due to the presence of the heat resistant coating 108. In a particular aspect, the recyclable flexible packaging material is suitable for use in making pouches through a pouching process that includes a heat sealing step. More particularly, the packaging material of the present disclosure can feed through a high-speed pouching production line including heat sealing, where the material does not undergo softening or stretching in conjunction with heat sealing, thereby preserving proper alignment of the material in the machinery. While not wishing to be bound to a particular theory, the heat resistant coating of the present disclosure may transmit sufficient heat to the underlying sealant film so that said sealant film forms a seal with itself when two ends of the material sheet are pressed together by heat sealing jaws. At the same time, the heat resistant coating sufficiently preserves the structural integrity of the films during heat sealing so as to reduce or prevent softening or deformation of the material. Further, in some instances, partial crosslinking of the print film by the EB radiation can further provide a heat resistance to aid in preserving the structural integrity of the film structure during heat sealing.

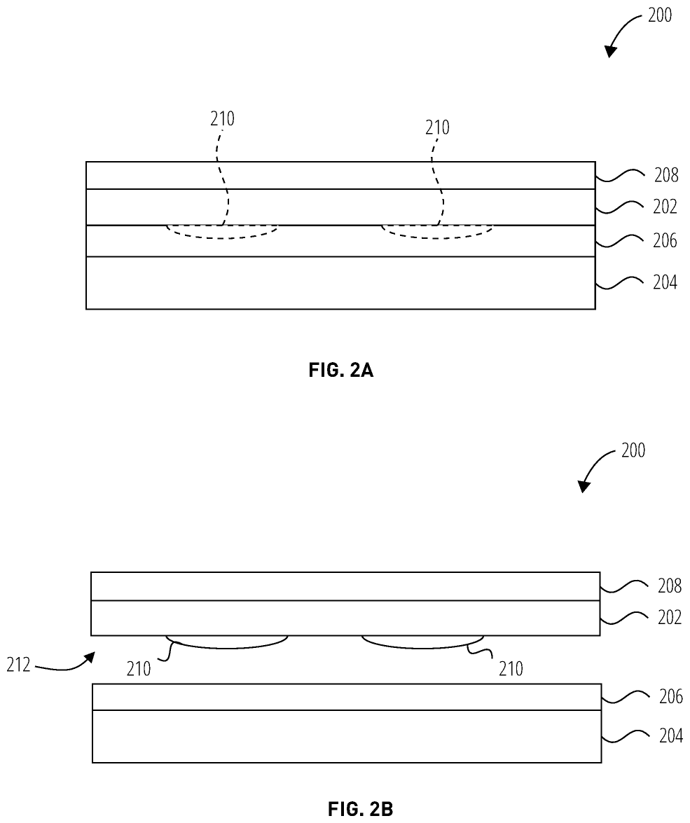

FIG. 2A and FIG. 2B show another embodiment of a recyclable flexible packaging material 200 in accordance with the present disclosure, comprising various elements including a print film 202 having ink 210 printed thereon and a heat resistant coating 208 covering at least part of the first surface (not visible) of the print film 202, and further a sealant film 204 laminated to the second surface 212 of the print film 202 with an adhesive 206. The description of the corresponding elements provided above with respect to FIGS. 1A and 1B also apply to these various elements, except for the particular arrangement as shown in FIGS. 2A and 2B resulting from reverse printing of the print film. As shown in FIG. 2A and in an exploded view in FIG. 2B in accordance with the embodiment the ink 210 is printed on the second surface 212 of a print film 202, i.e. reverse printed, so that the printed ink 210 is situated between the print film 202 and the sealant film 204. As previously discussed, the heat resistant coating 208 can be applied prior to printing (and lamination), or after printing (and lamination). In some embodiments the composition and thickness of the print film 202 and the heat resistant coating 208 can be selected so as to provide sufficient translucency or transparency to facilitate viewing of the reverse printed ink 210. In such embodiments, inclusion of a solventless adhesive 206 to laminate the print film 202 to the sealant film 204 may add a further benefit of preserving the integrity of the printed ink 210 during processing. As described above, in some embodiments, the print film 202 comprises PE and the sealant film 210 comprises PE. And in certain embodiments, the sealant film 210 comprises a multilayer film comprising a barrier layer such as an EVOH layer, with layers of PE disposed on either side. In such embodiments, the amount of EVOH in the multilayer sealant film can be less than about 5 wt % such that the multilayer sealant film is still recyclable and can be considered a near monopolymer film layer in accordance with this disclosure.

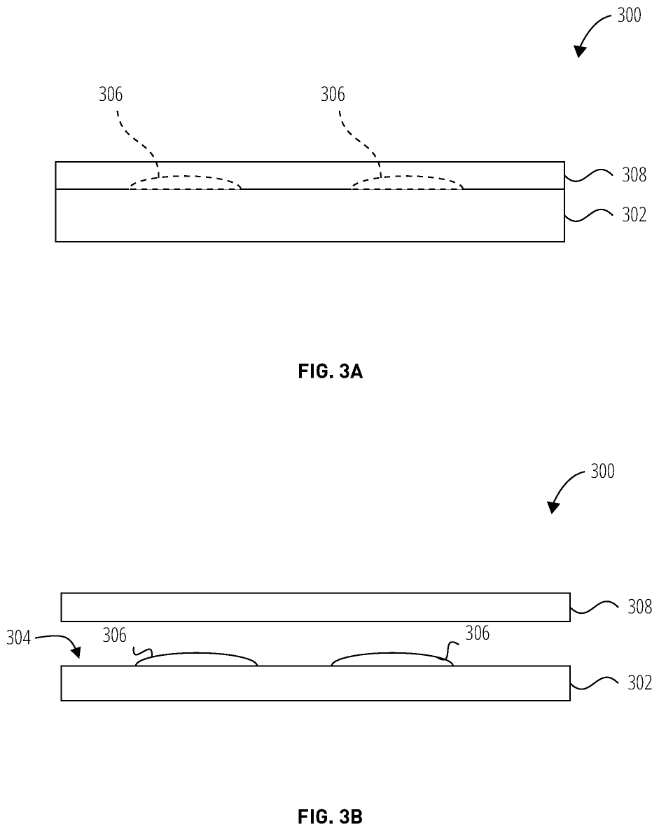

In addition to laminate materials, the present disclosure also encompasses recyclable flexible packaging material primarily comprising a monolayer polymer (or near monolayer polymer) film. As shown in cross-sectional view diagram of FIG. 3A and in an exploded view FIG. 3B, a recyclable flexible packaging material 300 comprises various elements including a print film 302 having a first surface 304 on which an ink 306 has been printed according to the methods described above. A heat resistant coating 308 is also disposed on the first surface 304 of the print film 302 (similar to the embodiment of FIGS. 1A and 1B but without the sealant film 110 laminated thereto). The description of the corresponding elements provided above with respect to FIGS. 1A and 1B also apply to these various elements.

In various embodiments, the print film 302 is made of a recyclable polymer suited for use in a flexible packaging application, particularly applications in which a sealant film layer is either not needed or not desirable. In more particular embodiments, the polyethylene is selected from low-density polyethylene (LDPE), linear low-density polyethylene (LLDPE), and combinations thereof. The print film 302 can be of a thickness of from about 0.7 mil to about 3.0 mil. As described above, in some embodiments, the print film 302 comprises a multilayer film comprising a barrier layer such as an EVOH layer, with layers of PE disposed on either side. In such embodiments, the amount of EVOH in the multilayer print film can be less than about 5 wt % such that the multilayer print film is still recyclable and can be considered a near monopolymer film layer in accordance with this disclosure.

References to approximations are made throughout this specification, such as by use of the term “about.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers. All ranges include both endpoints.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

What is claimed is:

1. A method of making a recyclable flexible packaging material with increased heat resistance, comprising the steps:
providing a print film comprising a polymer and having a first surface and a second surface;
printing an ink onto at least one of the first surface and the second surface;
coating the first surface with a radiation-curable coating formulation;
curing the radiation-curable coating formulation with a dose of radiation; and
laminating a sealant film comprising the polymer to the second surface of the print film using an adhesive.

2. The method of claim 1, wherein the polymer is polyethylene.

3. The method of claim 1, wherein the sealant film comprises a multilayer film comprising EVOH with polyethylene disposed on either side.

4. The method of claim 3, wherein the sealant film comprises less than about 5 wt % EVOH.

5. The method of claim 1, further comprising curing at least a portion of the print film with the dose of radiation.

6. The method of claim 1, wherein the curing step comprises delivering a dose of electron beam radiation.

7. The method of claim 6, wherein the dose is from about 40 kGy to about 120 kGy.

8. The method of claim 1, comprising printing the ink onto the first surface.

9. The method of claim 1, comprising printing the ink onto the second surface.

10. The method of claim 9, wherein the printing step is performed after the coating step.

11. A recyclable flexible packaging material, comprising:
a print film having a first surface and a second surface;
an ink printed on at least one of the first surface and second surface;
a heat resistant coating disposed on the first surface; and
a sealant film laminated to the second surface with an adhesive,
wherein the each of the print film and the sealant film comprises a recyclable polymer material.

12. The recyclable flexible packaging material of claim 11, wherein the print film and the sealant film both comprise the same recyclable polymer material.

13. The recyclable flexible packaging material of claim 12, wherein the recyclable polymer material is polyethylene.

14. The recyclable flexible packaging material of claim 11, wherein the ink is printed on the first surface of the print film.

15. The recyclable flexible packaging material of claim 11, wherein the ink is printed on the second surface of the print film.

16. The recyclable flexible packaging material of claim 11, wherein the print film has a thickness from about 0.7 mil to about 3.0 mil.

17. The recyclable flexible packaging material of claim 11, wherein sealant film comprises a multilayer film comprising EVOH with polyethylene disposed on either side, wherein the sealant film comprises less than 5 wt % EVOH.

18. The recyclable flexible packaging material of claim 11, wherein the heat resistant coating constitutes about 5 wt % or less of the total specific weight.

19. A recyclable flexible packaging material, comprising:
a print film having a first surface and a second surface;
an ink printed on the first surface;
a heat resistant coating disposed on the first surface, the heat resistant coating comprising a radiation-curable coating formulation having been cured by electron beam radiation;
wherein the print film comprises a recyclable polymer material.

20. The recyclable flexible packaging material of claim 19, wherein the print film comprises a multilayer film comprising EVOH with polyethylene disposed on either side, wherein the print film comprises less than 5 wt % EVOH.
